(19) United States
(12) Patent Application Publication
(10) Pub. No.: US 2023/0146383 A1
(43) Pub. Date: May 11, 2023

(54) LENS OPTICAL SYSTEM

(71) Applicant: SAMYANG OPTICS CO., LTD, Changwon-si, Gyeongsangnam-do (KR)

(72) Inventors: Jung Du LEE, Changwon-si (KR); Ju Yeon JO, Changwon-si (KR)

(73) Assignee: SAMYANG OPTICS CO., LTD, Changwon-si, Gyeongsangnam-do (KR)

(21) Appl. No.: 18/000,282

(22) PCT Filed: Jun. 3, 2020
(86) PCT No.: PCT/KR2020/007178

§ 371 Date: Nov. 29, 2022

(51) Int. Cl. G02B 13/00; G02B 9/12

(52) U.S. Cl. CPC G02B 13/0035; G02B 9/12

(57) ABSTRACT

A lens optical system includes a first lens group in which a first lens of an object side is composed of a meniscus lens having a negative refractive power, and having a positive refractive power as a whole, a second lens group arranged at an image side I than the first lens group, the second lens group being a focusing group for correcting a change in image distance depending on a change in object distance, being composed of two or less lenses, and having a positive refractive power as a whole, and a third lens group arranged at the image side I than the second lens group, the third lens group having a negative refractive power as a whole, in which a first lens of the image side I is composed of a concave or meniscus lens.

### BACKGROUND

### 1. Technical Field

The present invention relates to a lens optical system for photographing and a photographing apparatus including the same.

### 2. Description of the Related Art

Recently, miniaturization of photographing apparatuses, power saving functions, or the like have been required, and miniaturization of photographing devices using solid-state imaging devices such as CCD (charge-coupled devices) type image sensors or CMOS (complementary metal-oxide semiconductor) type image sensors have been required. Such photographing apparatuses include digital still cameras, video cameras, interchangeable lens cameras, or the like.

In addition, since the photographing apparatuses using the solid-state imaging devices are suitable for miniaturization, it is also applied to small information terminals such as mobile phones. Users have demands for high performance such as high resolution, a wide angle, or the like. In addition, as consumer expertise in cameras continues to increase, demand for short focal length lens systems such as wide-angle lens systems and telephoto lens systems is increasing.

A wide-angle field of view of such short focal length lens systems is an angle of view that is mainly used when photographing landscapes and short-distance people. Here, focusing is required to correct an image point that changes depending on a position of a subject, and the optical performance must be stable even for long-distance and short-distance objects.

A camera of the same type as a CSC (compact system camera) is a form that removes a pentaprism or a reflection mirror from tan existing DSLR (digital single lens reflex). Therefore, it has the benefit of being relatively small in volume and light, so it has good mobility and is easy to carry. However, in such a CSC, interchangeable lenses using a full-frame imaging device are required to obtain high-quality photographs. The larger the size of the imaging device, the larger the interchangeable lens and the larger the volume. When the interchangeable lens coupled to the CSC becomes heavy, it decreases portability and convenience. Therefore, even if a full-frame imaging device is used, it is necessary to reduce an overall length of a product to some extent.

### SUMMARY

Aspects of the present invention provide a lens optical system for photographing, which has a high resolution that operates in a wide angle area.

Aspects of the present invention also provide a lens optical system for photographing, which uses internal focusing with no change in length of an overall length, and is possible to reduce a length of a product and reduce the manufacturing cost while having a high resolution in a wide-angle area by properly considering an application position of an aspheric surface.

However, aspects of the present invention are not restricted to those set forth herein. The above and other aspects of the present invention will become more apparent to one of ordinary skill in the art to which the present invention pertains by referencing the detailed description of the present invention given below.

According to an aspect of an exemplary embodiment, there is provided a lens optical system, comprising: a first lens group in which a first lens of an object side is composed of a meniscus lens having a negative refractive power, and having a positive refractive power as a whole; a second lens group arranged at an image side I than the first lens group, the second lens group being a focusing group for correcting a change in image distance depending on a change in object distance, being composed of two or less lenses, and having a positive refractive power as a whole; and a third lens group arranged at the image side I than the second lens group, the third lens group having a negative refractive power as a whole, in which a first lens of the image side I is composed of a concave or meniscus lens, wherein when the second lens group is focused while moving, the first lens group and the third lens group are fixed to have a constant length of an overall length.

The lens optical system may satisfy the following equation:

$$1.16 \leq \frac{{f}_{B a c k}}{{f}_{Effective}} \leq 1.51 ,$$

where f_{Back} is a distance from a surface of the last lens of the lens optical system to an image plane, and f_{Effective} is an effective focal length of the lens optical system.

The lens optical system may satisfy the following equation:

$$1.26 \leq \frac{{L}_{Front}}{{L}_{Rear}} \leq 2.72 ,$$

where L_{Front} is a distance from an aperture of the optical system to a vertex surface of the object side of a first lens, and L_{Rear} is a distance from the aperture of the optical system to a vertex surface of the image side I of the last lens.

The lens optical system may satisfy the following equation:

0.52≤ΔL_{Focusing}≤1.34,

where ΔL_{Focusing} is a difference between positions of a focusing group in a direction of an optical axis for the case where the object distance is infinite and for the case where the object distance is an MOD (minimum of distance).

The lens optical system may satisfy the following equation:

$$0.5 \leq \frac{1}{{n}_{a}} \leq 0.6 ,$$

where nₐ is a reciprocal of an average refractive index of all lenses used in the optical system.

The second lens group may comprise at least one aspheric surface.

The last lens of the image side I included in the third lens group may have the negative refractive power.

The first lens of the object side O included in the first lens group may be the meniscus lens convex toward the object side O.

The first lens group or the third lens group may comprise one or more junction lenses.

The first lens group or the third lens group may comprise at least one aspheric surface.

In the present invention, an overall length is fixed by focusing using only one lens group inside an optical system. As described above, in order to correct the change in the position of the image point due to the change in the position of the object, a specific lens group inside a camera must be moved. This is called drawing-out. In many conventional interchangeable lenses, whole group drawing-out, front group drawing-out, rear group drawing-out, and inner focusing to move only an inner lens group are used, or various methods, such as a floating method, in which two or more lens groups are simultaneously moved and focused are used.

Among them, the inner focusing is advantageous in achieving dust proof and water drop proof since both the front group and the rear group are fixed. However, in the floating method, two or more lens groups are moved to correct aberration. Therefore, it is advantageous for aberration correction, but there is a problem that an internal structure of a camera is complicated and the weight is increased.

When the weight of the drawing-out group is heavy, it is unfavorable to an adjustment speed of AF (auto focusing). Therefore, in the present invention, it is proposed to employ an aspheric surface to satisfy high resolution performance while minimizing the weight of the extraction group. As described above, various aberrations resulting from a reduction in length of the overall length may be effectively controlled by using an aspheric lens.

Here, a surface to which an aspheric surface is applied should be selected as a surface close to an object side or an image side I of the optical system having a large correction effect. Here, when the front or rear group with the aspheric surface being applied moves during focusing, an effective diameter will increase, which will increase the manufacturing cost of the product and increase the weight of the product. In the present invention, by using the inner focusing with no change in length of the overall length, the application position of the aspheric surface may be properly considered. Therefore, the length of the product may be reduced while having the high resolution in the wide-angle area, and accordingly, the manufacturing cost may be reduced.

### BRIEF DESCRIPTION OF THE DRAWINGS

The above and other aspects and features of the present invention will become more apparent by describing in detail exemplary embodiments thereof with reference to the attached drawings, in which:

FIG. 1 is a view showing an optical layout showing an arrangement of lens components in a lens optical system according to a first embodiment of the present invention.

FIG. 2 is a view showing a ray fan diagram of the lens optical system at an infinite distance, according to the first embodiment of the present invention.

FIG. 3 is a view showing an optical layout showing an arrangement of lens components in a lens optical system according to a second embodiment of the present invention.

FIG. 4 is a view showing a ray fan diagram of the lens optical system at an infinite distance, according to the second embodiment of the present invention.

FIG. 5 is a view showing an optical layout showing an arrangement of lens components in a lens optical system according to a third embodiment of the present invention.

FIG. 6 is a view showing a ray fan diagram of the lens optical system at an infinite distance, according to the third embodiment of the present invention.

FIG. 7 is a view showing an optical layout showing an arrangement of lens components in a lens optical system according to a fourth embodiment of the present invention.

FIG. 8 is a view showing a ray fan diagram of the lens optical system at an infinite distance, according to the fourth embodiment of the present invention.

FIG. 9 is a view showing an optical layout showing an arrangement of lens components in a lens optical system according to a fifth embodiment of the present invention.

FIG. 10 is a view showing a ray fan diagram of the lens optical system at an infinite distance, according to the fifth embodiment of the present invention.

FIG. 11 shows a photographing apparatus having the lens optical system 100 according to the embodiments of the present invention.

### DETAILED DESCRIPTION OF THE EMBODIMENTS

Advantages and features of the disclosure and methods to achieve them will become apparent from the descriptions of exemplary embodiments herein below with reference to the accompanying drawings. However, the inventive concept is not limited to exemplary embodiments disclosed herein but may be implemented in various ways. The exemplary embodiments are provided for making the disclosure of the inventive concept thorough and for fully conveying the scope of the inventive concept to those skilled in the art. It is to be noted that the scope of the disclosure is defined only by the claims. Like reference numerals denote like elements throughout the descriptions.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein. Terms used herein are for illustrating the embodiments rather than limiting the present disclosure. As used herein, the singular forms are intended to include plural forms as well, unless the context clearly indicates otherwise. Throughout this specification, the word “comprise” and variations such as “comprises” or “comprising,” will be understood to imply the inclusion of stated elements but not the exclusion of any other elements.

Hereinafter, an embodiment of the present invention will be described in detail with reference to the accompanying drawings.

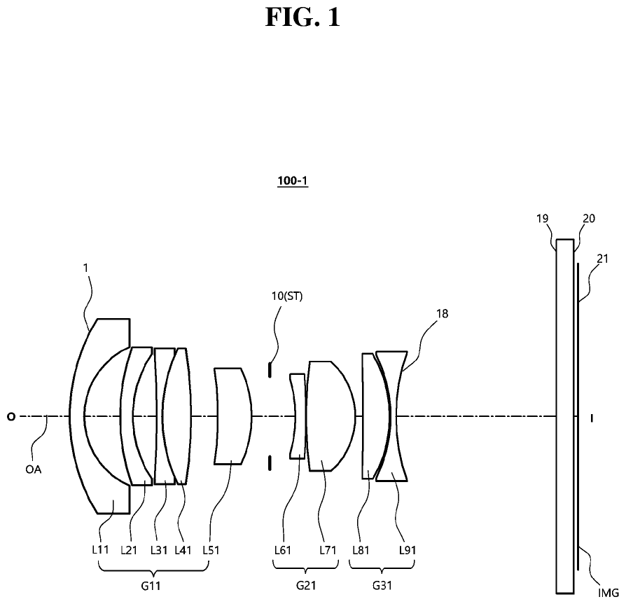

FIG. 1 is a view showing an optical layout showing an arrangement of lens components in a lens optical system according to a first embodiment of the present invention.

A lens optical system 100-1 includes a first lens group G11 having a positive refractive power, a second lens group G21 having a positive refractive power, and a third lens group G31 having a negative refractive power, which are arranged in order from an object side O to an image side I. In focusing, the first lens group G11 and the third lens group G31 are fixed to maintain a constant length of the overall length, and the second lens group G21 in the middle may be moved.

Hereinafter, the image side I may indicate a direction where an image plane IMG is positioned, in which an image is formed on the image plane IMG, and the object side O may indicate a direction in which a subject is positioned. In addition, the “object side” of a lens means, for example, the left side of the drawing toward a lens surface where the subject is positioned. “Aback side of the image I” may indicate the right side of the drawing toward a lens surface where the image plane is positioned. The image plane IMG may be, for example, an imaging device surface or an image sensor surface. The image sensor may include, for example, a sensor such as a CMOS (complementary metal oxide semiconductor) image sensor or a CCD (charge coupled device). The image sensor is not limited thereto, and may be, for example, a device that converts an image of a subject into an electrical image signal.

In the lens optical system according to various embodiments, the first lens group G11 may embody a wide angle by emitting light with a positive refractive power. In addition, an aperture ST may be arranged between the first lens group G11 and the second lens group G21.

When focusing from infinity to the nearest distance, the first lens group G11 and the third lens group G31 are fixed, the second lens group G21 may move independently and moves from the image side I to the object side O. When the first lens group G11 and the third lens group G31 are fixed in focusing, damage or impairment to the lens due to the protrusion of the first lens group G11 may be reduced, and it may contribute to miniaturization of the lens optical system by preventing an increase in length of the overall length.

In a general wide-angle lens optical system, a diameter of a lens positioned closest to the object side O increases, and an aspheric surface may be employed inside the first lens group positioned closest to the object side O so as to minimize aberration changes due to focusing. Further, in the present invention, an aspheric lens may be provided in the third lens group having a relatively small aperture. In a bright lens optical system having a small F number Fno, the aspheric lens must be employed to achieve sufficient resolution performance and small distortion. Therefore, the aspheric surface is employed, in which the aspheric surface is employed in the third lens group G31 positioned at the rear of the small aperture so that the maximum resolution performance may be obtained at a small cost. Preferably, the aspheric surface may be employed on the object side O surface of the lens positioned on the image side I immediately behind the aperture ST in order to increase the center resolution performance. In addition, the aspheric lens may be arranged on the uppermost side I of the third lens group G31 for correction of astigmatism and distortion.

Referring to FIG. 1, the first lens group G11 may include a first lens L11 having a negative refractive power, a second lens L21 having a negative refractive power, a third lens L31 having a negative refractive power, and a fourth lens L41 having a positive refraction power, and a fifth lens L51 having a positive refractive power. Among them, the third lens L31 and the fourth lens L41 may be double-junction lenses bonded to each other.

The first lens L11 and the second lens L21 may have a meniscus shape convex toward the object side O, the third lens L31 may be a biconcave lens, and the fourth lens L41 may be a biconvex lens. Further, the fifth lens L51 may be a meniscus lens convex toward the image side I. In particular, the second lens L21 may be the aspheric lens. The aspheric lens is a lens whose magnitude of a radius of curvature changes depending on a position offset from the center.

The second lens group G21 may include a sixth lens L61 having a negative refractive power and a seventh lens L71 having a positive refractive power. The sixth lens L61 may have the meniscus shape convex toward the image side I, and the seventh lens L71 may be the biconvex lens. Here, the sixth lens L61 may be the aspheric lens.

The third lens group G31 may include an eighth lens L81 having a positive refractive power and a ninth lens L91 having a negative refractive power. The eighth lens L81 may have the meniscus shape convex toward the image side I, and the ninth lens L91 may be the biconcave lens. Here, the eighth lens L81 may be the aspheric lens.

The lens optical system according to the first embodiment has the following characteristic values as a whole by a combination of individual lenses. Here, f denotes a focal length, Fno denotes an F number, and HFOV denotes a half angle of view.

f=18.5413 mm, Fno: 2.85, HFOV=50.06°

In addition, detailed design data of the lenses included in the lens optical system is shown in Table 1 below. The design data indicates information such as a radius of curvature of a lens, a thickness of a lens, an interval between lenses, a material of a lens material, or the like. Here, an object on the lens surface is added with a number (see the numbering of 1 to 17 in FIG. 1) indicating a surface of all lenses arranged from the object to the image. Among these numbers, “*” indicates a surface of the aspheric lens. In addition, the unit of Radius and Thickness is mm, “nd” denotes a refractive index, and “vd” denotes an Abbe number.

TABLE 1

| Surface | Radius | Thickness | nd | vd | Note |
|---|---|---|---|---|---|
| object | | D0 | | | |
| 1 | 25.899 | 2.1 | 1.92286 | 20.88 | Group 1 |
| 2 | 10.81 | 4.998 | | | (Fix) |
| 3* | 61.208 | 1.81 | 1.51423 | 63.699 | |
| 4* | 21.709 | 3.314 | | | |
| 5 | −123.315 | 0.8 | 1.497 | 81.6072 | |
| 6 | 22.134 | 4.01 | 2.001 | 29.1342 | |
| 7 | −60.582 | 3.847 | | | |
| 8 | −40.26 | 4.7 | 1.497 | 81.6072 | |
| 9 | −15.756 | 1.444 | | | |
| 10(stop) | infinity | D1 | | | |
| 11* | −19.9 | 1.5 | 1.83157 | 37.1993 | Group 2 |
| 12* | −44.623 | 0.1 | | | (Focusing) |
| 13 | 70.193 | 6.84 | 1.497 | 81.6072 | |
| 14 | −10.215 | D2 | | | |
| 15* | −459.178 | 3.77 | 1.76951 | 49.2992 | Group 3 |
| 16* | −16.19 | 0.15 | | | (Fix) |
| 17 | −19.533 | 0.7 | 1.72825 | 28.32 | |
| 18 | 27.335 | 22.444 | | | |
| 19 | infinity | 2.5 | 1.5168 | 64.1973 | Filter |
| 20 | infinity | 2.5 | | | |
| 21 | infinity | 0 | | | |

In the first embodiment shown in FIG. 1, the second lens L21 having object numbers 3 and 4, the sixth lens L61 having object numbers 11 and 12, and the eighth lens L81 having object numbers 15 and 16 are the aspheric lenses, respectively. When a direction of an optical axis OA is a z axis and a direction perpendicular to the direction of the optical axis direction is a y axis, the aspheric shape may be expressed by the following Equation 1 by making a direction of a light beam positive.

$$z = \frac{c {r}^{2}}{1 + \sqrt{1 - ( 1 + K ) {c}^{2} {r}^{2}}} + A {r}^{4} + B {r}^{6} + C {r}^{8} + D {r}^{10} + E {r}^{12} … \qquad [ Equation 1 ]$$

Here, Z denotes a distance from a vertex of the lens in the direction of the optical axis, r denotes a distance in the direction perpendicular to the optical axis OA, K denotes a conic constant, A, B, C, D, E, etc. denotes aspheric coefficients, and c represents a reciprocal of a radius of curvature 1/R at the vertex of the lens, respectively.

Data of specific aspheric coefficients having the surfaces of the aspheric lenses are shown in Table 2 below.

TABLE 2

| ASP | 3 | 4 | 11 | 12 | 15 | 16 |
|---|---|---|---|---|---|---|
| K | 9.181343 | 2.030985 | −2.535714 | −4.354985 | 10 | −0.413514 |
| A | 2.265641E−04 | 2.2840186E−04 | −3.2364193E−05 | 1.3354856E−04 | −2.9368249E−05 | 1.5582113E−05 |
| B | −2.3494280E−06 | −2.5018168E−06 | 4.2820552E−08 | 1.0132676E−06 | 5.6907757E−08 | −1.0367630E−07 |
| C | 1.5831092E−08 | 9.9266010E−09 | −4.6609142E−08 | −1.6043213E−08 | 2.8671109E−09 | 1.3333367E−09 |
| D | −7.6214502E−11 | −2.8220417E−11 | −5.5537973E−10 | −5.498949E−10 | 1.0762403E−11 | 2.3417940E−11 |
| E | 2.011977E−13 | 4.1393623E−14 | 2.4007200E−12 | 7.7404421E−12 | −1.9607130E−13 | −1.7084264E−13 |

Further, zoom data of the lens optical system according to the first embodiment when it is infinity in the first embodiment and when the magnification is − 1/40 times or − 1/50 times, is shown in Table 3 below. Here, D0 to D2 denote a variable distance, and “in Air” denotes a distance from the last surface of the optical system to the imaging device when there is no filter positioned in front of the imaging device. In addition, FOV is a field of view, which means a size of an area visible to the imaging device, and Fno means an F number. In addition, OAL denotes an overall length of the lens optical system, and denotes a distance from the object side to the image plane of the lens closest to the object side O of the lens optical system.

TABLE 3

| Config | Infinity | m = 1/40 | TL = 0.25 m |
|---|---|---|---|
| D0 | Infinity | 730.398 | 180.954 |
| D1 | 4.666 | 4.422 | 3.734 |
| D2 | 1.015 | 1.259 | 1.947 |
| in Air | 24.59 | 24.59 | 24.59 |
| FOV | 100.1 | 100.1 | 100 |
| Fno | 2.85 | 2.86 | 2.9 |
| OAL | 70.7079 | 70.7079 | 70.7079 |

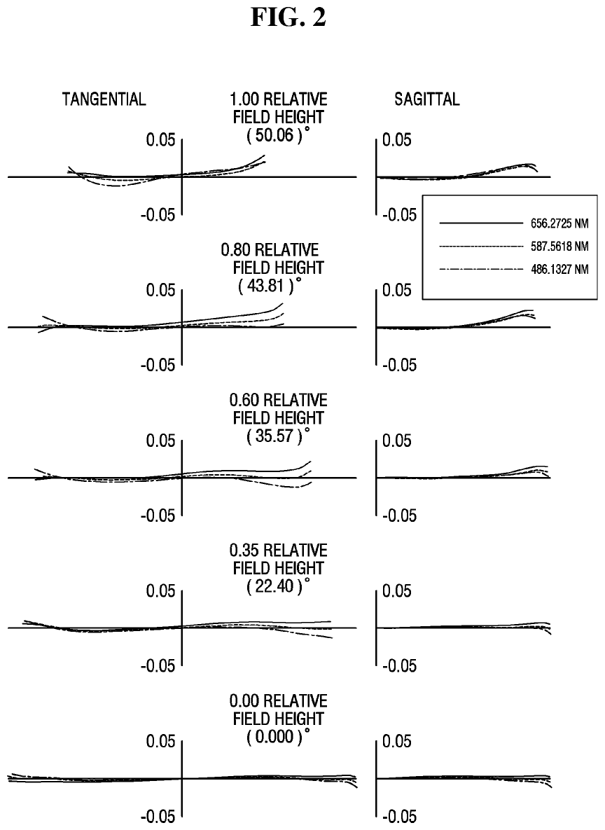

FIG. 2 is a view showing a ray fan diagram of the lens optical system at an infinite distance, according to the first embodiment of the present invention shown in FIG. 1. Here, a solid line denotes a 656.2725 NM wavelength (C-line), a dotted line denotes a 587.5618 NM wavelength (d-line), and a dashed line denotes a ray fan (unit: mm) for a 486.1327 NM wavelength (F-line).

These ray fans are plotted as a ray fan graph for the respective Tangential and Sagittal planes when the relative field heights are 0F, 0.35F, 0.60F, 0.80F and 1.00F.

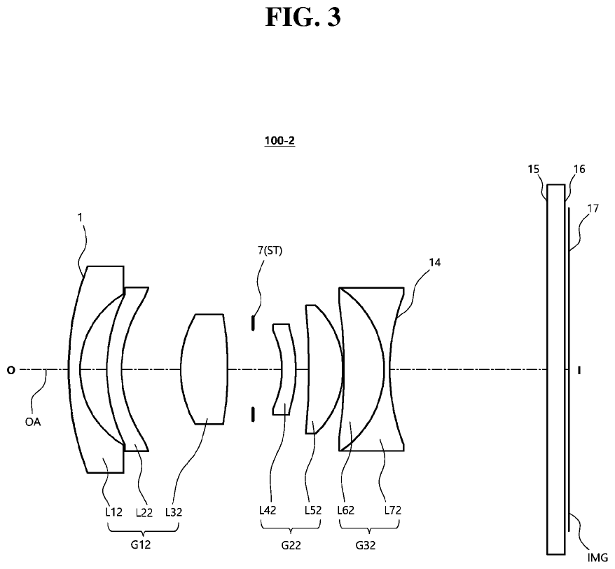

FIG. 3 is a view showing an optical layout showing an arrangement of lens components in a lens optical system according to a second embodiment of the present invention.

A lens optical system 100-2 includes a first lens group G12 having a positive refractive power, a second lens group G22 having a positive refractive power, and a third lens group G32 having a negative refractive power, which are arranged in order from an object side O to an image side I. In focusing, the first lens group G12 and the third lens group G32 are fixed to maintain a constant length of the overall length, and the second lens group G22 in the middle may be moved.

In the lens optical system according to various embodiments, the first lens group G12 may embody a wide angle by emitting light with a positive refractive power. In addition, an aperture ST may be arranged between the first lens group G12 and the second lens group G22.

When focusing from infinity to the nearest distance, the first lens group G12 and the third lens group G32 are fixed, the second lens group G22 may move independently and moves from the image side I to the object side O. When the first lens group G12 and the third lens group G32 are fixed in focusing, damage or impairment to the lens due to the protrusion of the first lens group G12 may be reduced, and it may contribute to miniaturization of the lens optical system by preventing an increase in length of the overall length.

Referring to FIG. 3, the first lens group G12 may include a first lens L12 having a negative refractive power, a second lens L22 having a negative refractive power, and a third lens L32 having a positive refractive power.

The first lens L12 and the second lens L22 may have a meniscus shape convex toward the object side O and the third lens L32 may be a biconvex lens. In particular, the second lens L22 may be the aspheric lens.

The second lens group G22 may include a fourth lens L42 having a negative refractive power and a fifth lens L52 having a positive refractive power. The fourth lens L42 may have the meniscus shape convex toward the image side I, and the fifth lens L52 may be the biconvex lens. Here, the fourth lens L42 may be the aspheric lens.

The third lens group G32 may include a sixth L62 having a positive refractive power and a seventh lens L72 having a negative refractive power. The sixth lens L62 may have the meniscus shape convex toward the image side I, and the seventh lens L72 may be the biconcave lens. Here, the sixth lens L62 and the seventh lens L72 may be the double-junction lenses bonded to each other.

The lens optical system according to the second embodiment has the following characteristic values as a whole by a combination of individual lenses.

f=18.54 mm, Fno: 2.9, HFOV=50.54°

In addition, detailed design data of the lenses included in the lens optical system is shown in Table 4 below. The design data indicates information such as a radius of curvature of a lens, a thickness of a lens, an interval between lenses, a material of a lens material, or the like. Here, an object on the lens surface is added with a number (see the numbering of 1 to 17 in FIG. 3) indicating a surface of all lenses arranged from the object to the image. Among these numbers, “*” indicates a surface of the aspheric lens. In addition, the unit of Radius and Thickness is mm, “nd” denotes a refractive index, and “vd” denotes an Abbe number.

TABLE 4

| Surface | Radius | Thickness | nd | vd | Note |
|---|---|---|---|---|---|
| object | | D0 | | | |
| 1 | 39.54 | 1.5 | 1.75893 | 50.1824 | Group 1 |
| 2 | 11.834 | 3.571 | | | (Fix) |
| 3* | 34.275 | 2 | 1.51633 | 64.064 | |
| 4* | 19.347 | 7.756 | | | |
| 5 | 14.955 | 6.28 | 1.57499 | 63.131 | |
| 6 | −46.077 | 3.65 | | | |
| 7(stop) | infinity | D1 | | | |
| 8* | −10.387 | 1.8 | 1.80755 | 40.889 | Group 2 |
| 9* | −12.752 | 1.738 | | | (Focusing) |
| 10 | −85.463 | 4.57 | 1.74242 | 50.908 | |
| 11 | −11.836 | D2 | | | |
| 12 | −65.486 | 5.31 | 1.7725 | 49.624 | Group 3 |
| 13 | −13.129 | 0.7 | 1.67053 | 28.376 | (Fix) |
| 14 | 28.406 | 20.981 | | | |
| 15 | infinity | 2.5 | 1.5168 | 64.197 | Filter |
| 16 | infinity | 0.5 | | | |
| 17 | infinity | 0 | | | |

In the second embodiment shown in FIG. 3, the second lens L22 having object numbers 3 and 4 and the fourth lens L42 having object numbers 8 and 9 are the aspheric lenses, respectively. Data of specific aspheric coefficients having the surfaces of the aspheric lenses are shown in Table 5 below.

TABLE 5

| ASP | 3 | 4 | 8 | 9 |
|---|---|---|---|---|
| K | 0 | 0.564272 | 0 | 0 |
| A | 1.3772053E−04 | 1.2838982E−04 | 2.5448652E−04 | 3.7687136E−04 |
| B | −7.4128528E−07 | −1.1652675E−06 | 3.4366107E−06 | 4.6451303E−06 |
| C | 3.7572383E−09 | 9.0559377E−09 | 1.1323119E−07 | 1.5720943E−08 |
| D | −2.1921453E−11 | −1.2447801E−10 | −9.1164971E−09 | −2.8441547E−09 |
| E | 0.0000000E+00 | 4.0601579E−13 | 1.1667053E−10 | 2.8967166E−11 |

Further, zoom data of the lens optical system according to the second embodiment when it is infinity in the second embodiment and when the magnification is − 1/40 times or − 1/50 times, is shown in Table 6 below. Here, D0 to D2 denote a variable distance, and “in Air” denotes a distance from the last surface of the optical system to the imaging device when there is no filter positioned in front of the imaging device. In addition, FOV is a field of view, which means a size of an area visible to the imaging device, and Fno means an F number. In addition, OAL denotes an overall length of the lens optical system, and denotes a distance from the object side to the image plane of the lens closest to the object side O of the lens optical system.

TABLE 6

| Config | Infinity | m = 1/40 | TL = 0.25 m |
|---|---|---|---|
| D0 | infinity | 730.398 | 183.993 |
| D1 | 3.517 | 3.337 | 2.839 |
| D2 | 0.1 | 0.28 | 0.778 |
| in Air | 23.128 | 23.128 | 23.128 |
| FOV | 101.07 | 101.21 | 101.48 |
| Fno | 2.9 | 2.92 | 2.98 |
| OAL | 65.973 | 65.973 | 65.973 |

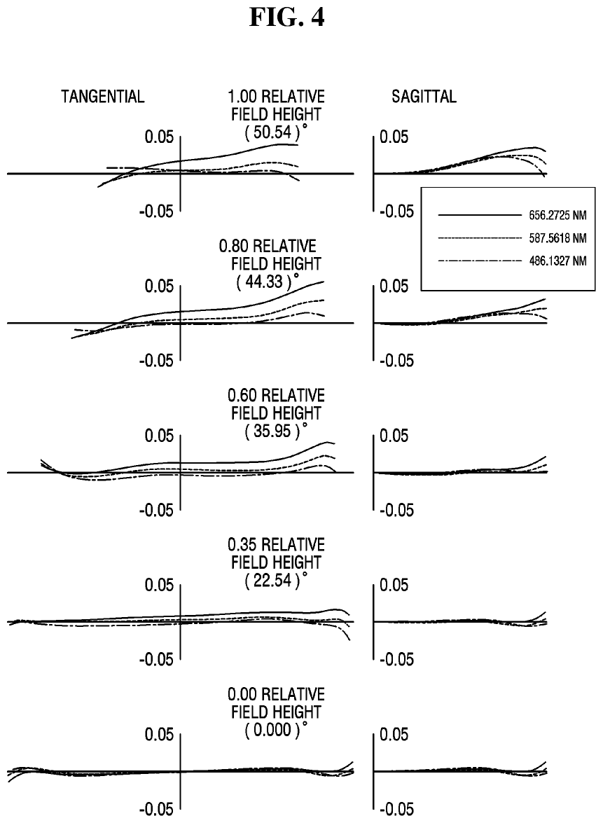

FIG. 4 is a view showing a ray fan diagram of the lens optical system at an infinite distance, according to the second embodiment of the present invention shown in FIG. 3. Here, a solid line denotes a 656.2725 NM wavelength (C-line), a dotted line denotes a 587.5618 NM wavelength (d-line), and a dashed line denotes a ray fan (unit: mm) for a 486.1327 NM wavelength (F-line).

These ray fans are plotted as a ray fan graph for the respective Tangential and Sagittal planes when the relative field heights are 0F, 0.35F, 0.60F, 0.80F and 1.00F.

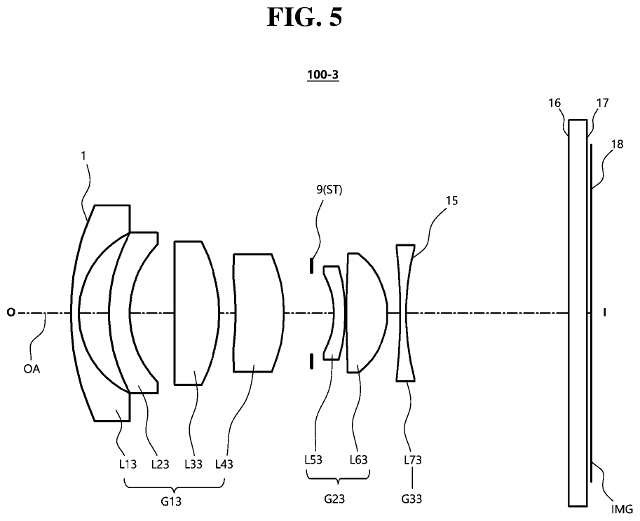

FIG. 5 is a view showing an optical layout showing an arrangement of lens components in a lens optical system according to a third embodiment of the present invention.

A lens optical system 100-3 includes a first lens group G13 having a positive refractive power, a second lens group G23 having a positive refractive power, and a third lens group G33 having a negative refractive power, which are arranged in order from an object side O to an image side I. In focusing, the first lens group G13 and the third lens group G33 are fixed to maintain a constant length of the overall length, and the second lens group G23 in the middle may be moved.

In the lens optical system according to various embodiments, the first lens group G13 may embody a wide angle by emitting light with a positive refractive power. In addition, an aperture ST may be arranged between the first lens group G13 and the second lens group G23.

When focusing from infinity to the nearest distance, the first lens group G13 and the third lens group G33 are fixed, the second lens group G23 may move independently and moves from the image side I to the object side O. When the first lens group G13 and the third lens group G33 are fixed in focusing, damage or impairment to the lens due to the protrusion of the first lens group G13 may be reduced, and it may contribute to miniaturization of the lens optical system by preventing an increase in length of the overall length.

Referring to FIG. 5, the first lens group G13 may include a first lens L13 having a negative refractive power, a second lens L23 having a negative refractive power, a third lens L33 having a positive refractive power, and a fourth lens L43 having a positive refractive power. The first lens L13 and the second lens L23 may have a meniscus shape convex toward the object side O and the third lens L33 may be a biconvex lens. In particular, the third lens L33 and the fourth lens L43 may be the aspheric lens.

The second lens group G23 may include a fifth lens L53 having a negative refractive power and a sixth lens L63 having a positive refractive power. The fifth lens L53 may have the meniscus shape convex toward the image side I, and the sixth lens L63 may be the biconvex lens. Here, the fifth lens L53 may be the aspheric lens.

The third lens group G33 may include a seventh lens L73 having a negative refractive power. The seventh lens L73 may be the biconcave lens.

The lens optical system according to the third embodiment has the following characteristic values as a whole by a combination of individual lenses.

f=18.01 mm, Fno: 2.9, HFOV=51.07°

In addition, detailed design data of the lenses included in the lens optical system is shown in Table 7 below. The design data indicates information such as a radius of curvature of a lens, a thickness of a lens, an interval between lenses, a material of a lens material, or the like. Here, an object on the lens surface is added with a number (see the numbering of 1 to 18 in FIG. 5) indicating a surface of all lenses arranged from the object to the image. Among these numbers, “*” indicates a surface of the aspheric lens. In addition, the unit of Radius and Thickness is mm, “nd” denotes a refractive index, and “vd” denotes an Abbe number.

TABLE 7

| Surface | Radius | Thickness | nd | vd | Note |
|---|---|---|---|---|---|
| object | | D0 | | | |
| 1 | 32.121 | 1 | 1.77621 | 49.6235 | Group 1 |
| 2 | 11.052 | 3.733 | | | (Fix) |
| 3 | 20.668 | 2.57 | 2.01489 | 19.3168 | |
| 4 | 12.2 | 5.507 | | | |
| 5* | 106.3 | 5.6 | 1.88353 | 37.2955 | |
| 6* | −16.856 | 2.007 | | | |
| 7* | −34.102 | 6.02 | 1.51645 | 63.9953 | |
| 8* | −19.049 | 3.987 | | | |
| 9(stop) | infinity | D1 | | | |
| 10* | −8.346 | 1.41 | 1.69989 | 30.6594 | Group 2 |
| 11* | −10.787 | 0.1 | | | (Focusing) |
| 12 | 115.168 | 5.12 | 1.48914 | 70.4402 | |
| 13 | −9.346 | D2 | | | |
| 14 | −70.013 | 0.7 | 1.85505 | 23.7844 | Group 3 |
| 15 | 32.203 | 20.232 | | | (Fix) |
| 16 | infinity | 2.5 | 1.51872 | 64.1973 | Filter |
| 17 | infinity | 0.5 | | | |
| 18 | infinity | 0 | | | |

In the third embodiment shown in FIG. 5, the third lens L33 having object numbers 5 and 6, the fourth lens L43 having object numbers 7 and 8, and the fifth lens L53 having object numbers 10 and 11 are the aspheric lenses, respectively. Data of specific aspheric coefficients having the surfaces of the aspheric lenses are shown in Table 8 below.

TABLE 8

| ASP | 5 | 6 | 7 | 8 | 10 | 11 |
|---|---|---|---|---|---|---|
| K | 0 | 0 | 0 | 0 | 0 | 0 |
| A | −5.5185818E−05 | 1.0317544E−04 | 3.1031005E−04 | 1.6104358E−05 | 5.1971397E−04 | 6.2635150E−04 |
| B | −1.1426079E−07 | −1.1704046E−06 | −3.2796971E−06 | −1.7810915E−06 | 1.1065998E−05 | 9.6748737E−06 |
| C | 4.4778197E−10 | 1.0092008E−08 | 3.9359530E−08 | 6.1277817E−08 | −1.8986103E−07 | −1.0517952E−07 |
| D | 2.5289970E−11 | −3.8220355E−11 | −2.0804634E−10 | −1.0653216E−09 | −6.3101929E−09 | −3.8711202E−09 |
| E | 1.5024420E−13 | 9.4221574E−14 | −2.0321963E−13 | 7.3923422E−12 | 1.2226286E−10 | 6.0125094E−11 |

Further, zoom data of the lens optical system according to the third embodiment when it is infinity in the third embodiment and when the magnification is − 1/40 times or − 1/50 times, is shown in Table 9 below. Here, D0 to D2 denote a variable distance, and “in Air” denotes a distance from the last surface of the optical system to the imaging device when there is no filter positioned in front of the imaging device. In addition, FOV is a field of view, which means a size of an area visible to the imaging device, and Fno means an F number. In addition, OAL denotes an overall length of the lens optical system, and denotes a distance from the object side to the image plane of the lens closest to the object side O of the lens optical system.

TABLE 9

| Config | Infinity | m = 1/40 | TL = 0.25 m |
|---|---|---|---|
| D0 | infinity | 730.39806 | 183.99313 |
| D1 | 2.245 | 2.0910275 | 1.6652595 |
| D2 | 1.592 | 1.7459725 | 2.1717405 |
| in Air | 22.378 | 22.378 | 22.378 |
| FOV | 102.14 | 102.17 | 102.16 |
| Fno | 2.9 | 2.92 | 2.98 |
| OAL | 64.3225 | 64.3225 | 64.3225 |

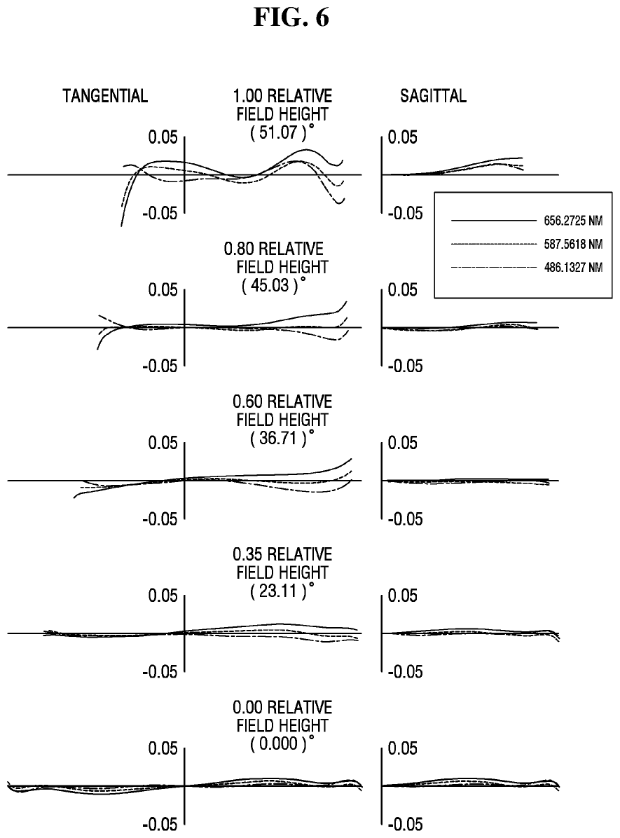

FIG. 6 is a view showing a ray fan diagram of the lens optical system at an infinite distance, according to the third embodiment of the present invention shown in FIG. 5. Here, a solid line denotes a 656.2725 NM wavelength (C-line), a dotted line denotes a 587.5618 NM wavelength (d-line), and a dashed line denotes a ray fan (unit: mm) for a 486.1327 NM wavelength (F-line).

These ray fans are plotted as a ray fan graph for the respective Tangential and Sagittal planes when the relative field heights are 0F, 0.35F, 0.60F, 0.80F and 1.00F.

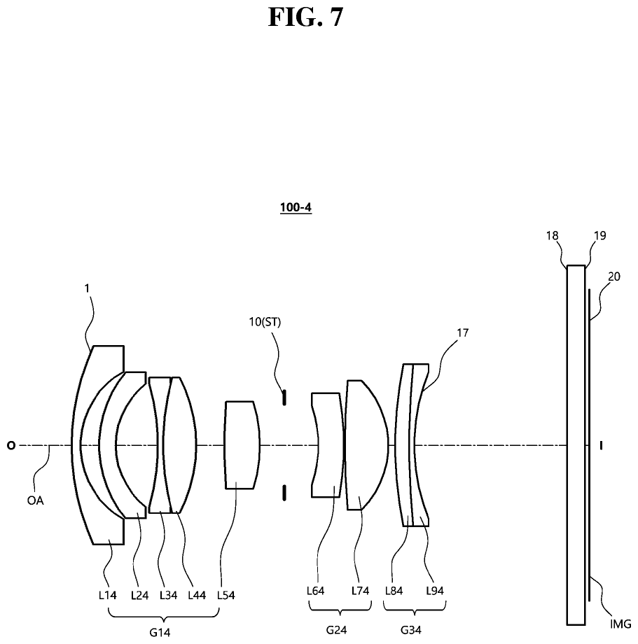

FIG. 7 is a view showing an optical layout showing an arrangement of lens components in a lens optical system according to a fourth embodiment of the present invention.

A lens optical system 100-4 includes a first lens group G14 having a positive refractive power, a second lens group G24 having a positive refractive power, and a third lens group G34 having a negative refractive power, which are arranged in order from an object side O to an image side I. In focusing, the first lens group G14 and the third lens group G34 are fixed to maintain a constant length of the overall length, and the second lens group G24 in the middle may be moved.

In the lens optical system according to various embodiments, the first lens group G14 may embody a wide angle by emitting light with a positive refractive power. In addition, an aperture ST may be arranged between the first lens group G14 and the second lens group G24.

When focusing from infinity to the nearest distance, the first lens group G14 and the third lens group G34 are fixed, the second lens group G24 may move independently and moves from the image side I to the object side O. When the first lens group G14 and the third lens group G34 are fixed in focusing, damage or impairment to the lens due to the protrusion of the first lens group G14 may be reduced, and it may contribute to miniaturization of the lens optical system by preventing an increase in length of the overall length.

Referring to FIG. 7, the first lens group G14 may include a first lens L14 having a negative refractive power, a second lens L24 having a negative refractive power, a third lens L34 having a negative refractive power, a fourth lens L44 having a positive refractive power, and a fifth lens L54 having a positive refractive power. Among them, the third lens L34 and the fourth lens L44 may be double-junction lenses bonded to each other.

The first lens L14 and the second lens L24 may have a meniscus shape convex toward the object side O, the third lens L34 may be a biconcave lens, the fourth lens L44 may be a biconvex lens and the third lens L54 may be a biconvex lens. In particular, the surface of image side I of the fourth lens L44, and the fifth lens L54 may be the aspheric lens.

The second lens group G24 may include a sixth lens L64 having a negative refractive power and a seventh lens L74 having a positive refractive power. The sixth lens L64 may have the meniscus shape convex toward the image side I, and the seventh lens L74 may be the biconvex lens. Here, the sixth lens L64 may be the aspheric lens.

The third lens group G34 may include an eighth lens L84 having a positive refractive power and a ninth lens L94 having a negative refractive power. The eighth lens L84 and the ninth lens L94 may have the meniscus shape convex toward the image side I. Here, the eighth lens L84 and the ninth lens L94 may be the double-junction lenses bonded to each other.

The lens optical system according to the fourth embodiment has the following characteristic values as a whole by a combination of individual lenses.

f=18.54 mm, Fno: 2.85, HFOV=50.54°

In addition, detailed design data of the lenses included in the lens optical system is shown in Table 10 below. The design data indicates information such as a radius of curvature of a lens, a thickness of a lens, an interval between lenses, a material of a lens material, or the like. Here, an object on the lens surface is added with a number (see the numbering of 1 to 20 in FIG. 7) indicating a surface of all lenses arranged from the object to the image. Among these numbers, “*” indicates a surface of the aspheric lens. In addition, the unit of Radius and Thickness is mm, “nd” denotes a refractive index, and “vd” denotes an Abbe number.

TABLE 10

| Surface | Radius | Thickness | nd | vd | Note |
|---|---|---|---|---|---|
| object | | D0 | | | |
| 1 | 33.276 | 1.2 | 1.72916 | 54.6727 | Group 1 |
| 2 | 11.872 | 2.634 | | | (Fix) |
| 3 | 16.115 | 2.27 | 1.92286 | 20.88 | |
| 4 | 10.751 | 5.832 | | | |
| 5 | −30.878 | 0.7 | 1.497 | 81.6072 | |
| 6 | 36.447 | 4.54 | 1.7721 | 49.3032 | |
| 7* | −18.949 | 3.983 | | | |
| 8* | 600 | 4.82 | 1.51453 | 63.9953 | |
| 9* | −20.115 | 3.921 | | | |
| 10(stop) | infinity | D1 | | | |
| 11* | −16.334 | 3.51 | 1.83441 | 37.2845 | Group 2 |
| 12* | −25.882 | 0.139 | | | (Focusing) |
| 13 | 111.249 | 5.96 | 1.497 | 81.6072 | |
| 14 | −12.75 | D2 | | | |
| 15 | 56.588 | 1.92 | 1.7725 | 49.6235 | Group 3 |
| 16 | 103.705 | 0.7 | 1.92286 | 20.88 | (Fix) |
| 17 | 27.431 | 21.16 | | | |
| 18 | infinity | 2.5 | 1.5168 | 64.1973 | Filter |
| 19 | infinity | 0.5 | | | |
| 20 | infinity | 0 | | | |

In the fourth embodiment shown in FIG. 7, the surface of the image side I of the second lens L34 having the object number 7, the fifth lens L54 having the object number 8 and 9 and the sixth lens L64 having object numbers 11 and 12 are the aspheric lenses, respectively. Data of specific aspheric coefficients having the surfaces of the aspheric lenses are shown in Table 11 below.

TABLE 11

| ASP | 7 | 8 | 9 | 11 | 12 |
|---|---|---|---|---|---|
| K | 1.936355 | 10 | −2.314487 | 0 | 0 |
| A | 1.1283455E−04 | 1.7490627E−04 | 2.5327092E−06 | 3.9282154E−05 | 1.1823477E−04 |
| B | −4.7811741E−07 | −2.0315041E−06 | −7.6589270E−07 | 1.3248052E−06 | 8.1404975E−07 |
| C | 7.6947208E−09 | 6.1445825E−08 | 4.3551831E−08 | −5.1379063E−08 | −1.2513880E−08 |
| D | −5.2757301E−11 | −1.1447725E−09 | −7.1858941E−10 | 9.8508375E−10 | 1.1794572E−10 |
| E | 2.8086849E−13 | 1.5295811E−11 | 7.2660909E−12 | −8.7650034E−12 | −6.5969145E−13 |
| F | 0.0000000E+00 | −7.4846081E−14 | 0.0000000E+00 | 0.0000000E+00 | 0.0000000E+00 |

Further, zoom data of the lens optical system according to the fourth embodiment when it is infinity in the fourth embodiment and when the magnification is − 1/40 times or − 1/50 times, is shown in Table 14 below. Here, D0 to D2 denote a variable distance, and “in Air” denotes a distance from the last surface of the optical system to the imaging device when there is no filter positioned in front of the imaging device. In addition, FOV is a field of view, which means a size of an area visible to the imaging device, and Fno means an F number. In addition, OAL denotes an overall length of the lens optical system, and denotes a distance from the object side to the image plane of the lens closest to the object side O of the lens optical system.

TABLE 12

| Config | Infinity | m = 1/40 | TL = 0.25 m |
|---|---|---|---|
| D0 | infinity | 730.39806 | 180.9535 |
| D1 | 4.207 | 3.915 | 2.993 |
| D2 | 1 | 1.292 | 2.214 |
| in Air | 23.306 | 23.306 | 23.306 |
| FOV | 101.08 | 101.34 | 101.96 |
| Fno | 2.85 | 2.86 | 2.87 |
| OAL | 71 | 71 | 71 |

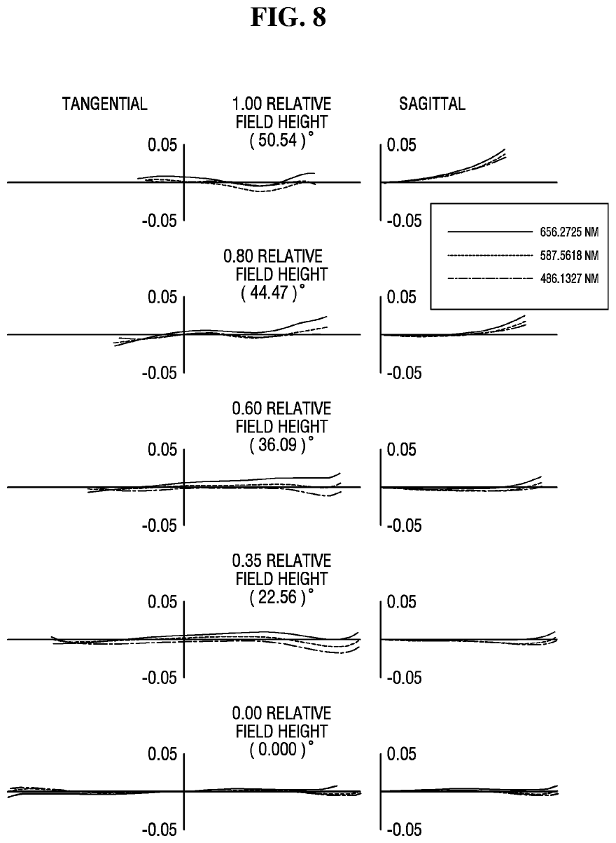

FIG. 8 is a view showing a ray fan diagram of the lens optical system at an infinite distance, according to the fourth embodiment of the present invention shown in FIG. 7. Here, a solid line denotes a 656.2725 NM wavelength (C-line), a dotted line denotes a 587.5618 NM wavelength (d-line), and a dashed line denotes a ray fan (unit: mm) for a 486.1327 NM wavelength (F-line).

These ray fans are plotted as a ray fan graph for the respective Tangential and Sagittal planes when the relative field heights are 0F, 0.35F, 0.60F, 0.80F and 1.00F.

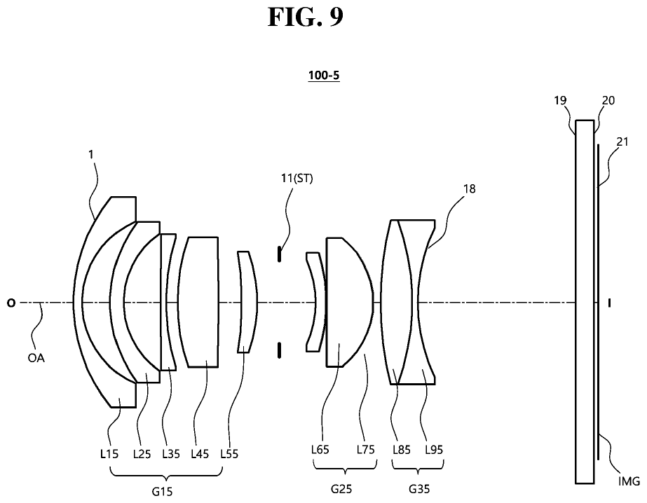

FIG. 9 is a view showing an optical layout showing an arrangement of lens components in a lens optical system according to a fifth embodiment of the present invention.

A lens optical system 100-5 includes a first lens group G15 having a positive refractive power, a second lens group G25 having a positive refractive power, and a third lens group G35 having a negative refractive power, which are arranged in order from an object side O to an image side I. In focusing, the first lens group G15 and the third lens group G35 are fixed to maintain a constant length of the overall length, and the second lens group G25 in the middle may be moved.

In the lens optical system according to various embodiments, the first lens group G15 may embody a wide angle by emitting light with a positive refractive power. In addition, an aperture ST may be arranged between the first lens group G15 and the second lens group G25.

When focusing from infinity to the nearest distance, the first lens group G15 and the third lens group G35 are fixed, the second lens group G25 may move independently and moves from the image side I to the object side O. When the first lens group G15 and the third lens group G35 are fixed in focusing, damage or impairment to the lens due to the protrusion of the first lens group G15 may be reduced, and it may contribute to miniaturization of the lens optical system by preventing an increase in length of the overall length.

Referring to FIG. 9, the first lens group G15 may include a first lens L15 having a negative refractive power, a second lens L25 having a negative refractive power, a third lens L35 having a negative refractive power, a fourth lens L45 having a positive refractive power and a fifth lens L55 having a positive refractive power.

The first lens L15, the second lens L25 and the third lens L35 may have a meniscus shape convex toward the object side O, the fourth lens L45 may be a biconvex lens and the fifth lens L55 may have a meniscus shape convex toward the image side I. In particular, the surfaces of the object side O of the second lens L25 and the fifth lens L55 may be the aspheric lens.

The second lens group G25 may include a sixth lens L65 having a negative refractive power and a seventh lens L75 having a positive refractive power. The sixth lens L65 may have the meniscus shape convex toward the image side I, and the seventh lens L75 may be the biconvex lens. Here, the sixth lens L65 may be the aspheric lens.

The third lens group G35 may include an eighth L85 having a positive refractive power and a ninth lens L95 having a negative refractive power. The eighth lens L85 may have the biconvex lens and the ninth lens L95 may be the biconcave lens. Here, the eighth lens L85 and the ninth lens L95 may be the double-junction lenses bonded to each other.

The lens optical system according to the fifth embodiment has the following characteristic values as a whole by a combination of individual lenses.

f=18.48 mm, Fno: 2.81, HFOV=50.66°

In addition, detailed design data of the lenses included in the lens optical system is shown in Table 13 below. The design data indicates information such as a radius of curvature of a lens, a thickness of a lens, an interval between lenses, a material of a lens material, or the like. Here, an object on the lens surface is added with a number (see the numbering of 1 to 21 in FIG. 9) indicating a surface of all lenses arranged from the object to the image. Among these numbers, “*” indicates a surface of the aspheric lens. In addition, the unit of Radius and Thickness is mm, “nd” denotes a refractive index, and “vd” denotes an Abbe number.

TABLE 13

| Surface | Radius | Thickness | nd | vd | Note |
|---|---|---|---|---|---|
| object | | D0 | | | |
| 1 | 22.694 | 1.2 | 1.92286 | 20.8800 | Group 1 |
| 2 | 12.121 | 3.841 | | | (Fix) |
| 3* | 20.062 | 1.8 | 1.51453 | 63.9953 | |
| 4 | 11.433 | 5.067 | | | |
| 5 | 433.605 | 0.8 | 1.44326 | 86.8238 | |
| 6 | 32.561 | 1.527 | | | |
| 7 | 26.819 | 5.58 | 1.98944 | 29.6173 | |
| 8 | −231.393 | 3.147 | | | |
| 9* | −39.728 | 2.15 | 1.51633 | 64.0641 | |
| 10 | −19.64 | 3.529 | | | |
| 11(stop) | infinity | D1 | | | |
| 12* | −14.826 | 1.5 | 1.83441 | 37.2844 | Group 2 |
| 13* | −18.659 | 0.1 | | | (Focusing) |
| 14 | −538.951 | 6.31 | 1.51822 | 75.9826 | |
| 15 | −11.143 | D2 | | | |
| 16 | 46.373 | 4.3 | 1.7725 | 49.6235 | Group 3 |
| 17 | −3.32E+01 | 0.7 | 1.78893 | 24.4904 | (Fix) |
| 18 | 2.36E+01 | 21.561 | | | |
| 19 | infinity | 2.5 | 1.5168 | 64.1973 | Filter |
| 20 | infinity | 0.5 | | | |
| 21 | infinity | 0 | | | |

In the fifth embodiment shown in FIG. 9, the surface of the object side O of the second lens L25 having the object number 3, the surface of the object side O of the fifth lens L55 having the object number 9, and the sixth lens L65 having object numbers 12 and 13 are the aspheric lenses, respectively. Data of specific aspheric coefficients having the surfaces of the aspheric lenses are shown in Table 14 below.

TABLE 14

| ASP | 3 | 9 | 12 | 13 |
|---|---|---|---|---|
| K | 0 | 4.651334 | 0 | −2.590709 |
| A | 1.0172441E−05 | 3.0168746E−05 | −1.5884728E−05 | 5.6352384E−05 |
| B | 1.6049965E−07 | −1.3022903E−07 | −7.4945777E−07 | 0.0000000E+00 |
| C | −1.0225932E−09 | 1.9289572E−08 | −3.2461593E−08 | 0.0000000E+00 |
| D | 6.5949197E−12 | −5.9842790E−10 | 5.5357337E−10 | 0.0000000E+00 |
| E | 0.0000000E+00 | 9.4593811E−12 | −7.7676421E−12 | 0.0000000E+00 |
| F | 0.0000000E+00 | −5.8508252E−14 | 0.0000000E+00 | 0.0000000E+00 |

Further, zoom data of the lens optical system according to the fifth embodiment when it is infinity in the fifth embodiment and when the magnification is − 1/40 times or − 1/50 times, is shown in Table 15 below. Here, D0 to D2 denote a variable distance, and “in Air” denotes a distance from the last surface of the optical system to the imaging device when there is no filter positioned in front of the imaging device. In addition, FOV is a field of view, which means a size of an area visible to the imaging device, and Fno means an F number. In addition, OAL denotes an overall length of the lens optical system, and denotes a distance from the object side to the image plane of the lens closest to the object side O of the lens optical system.

TABLE 15

| Config | Infinity | m = 1/40 | TL = 0.25 m |
|---|---|---|---|
| D0 | infinity | 730.39806 | 180.9535 |
| D1 | 4.392 | 4.147 | 3.292 |
| D2 | 1 | 1.245 | 2.1 |
| in Air | 23.707 | 23.707 | 23.707 |
| FOV | 101.31 | 101.19 | 100.58 |
| Fno | 2.82 | 2.83 | 2.87 |
| OAL | 71.0039 | 71.0039 | 71.0039 |

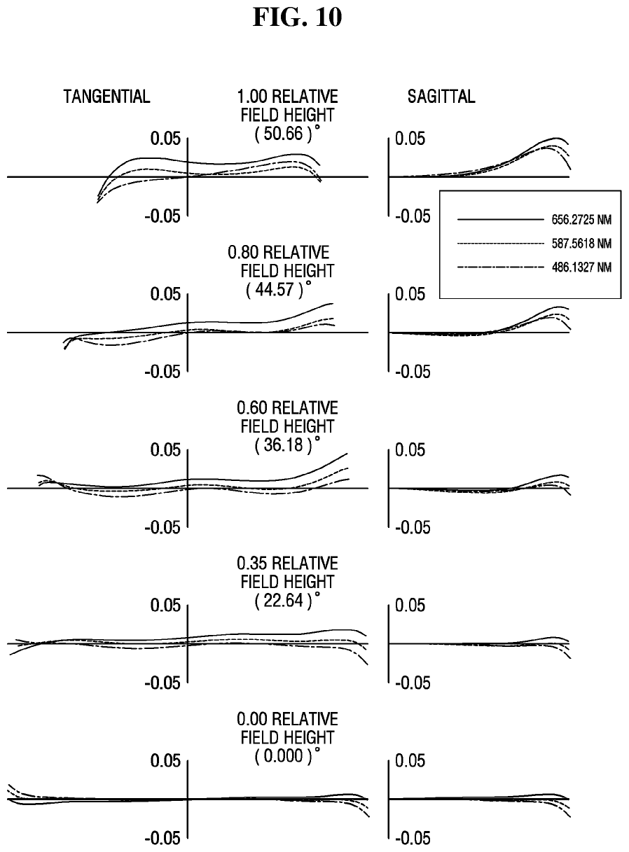

FIG. 10 is a view showing a ray fan diagram of the lens optical system at an infinite distance, according to the fifth embodiment of the present invention shown in FIG. 9. Here, a solid line denotes a 656.2725 NM wavelength (C-line), a dotted line denotes a 587.5618 NM wavelength (d-line), and a dashed line denotes a ray fan (unit: mm) for a 486.1327 NM wavelength (F-line).

These ray fans are plotted as a ray fan graph for the respective Tangential and Sagittal planes when the relative field heights are 0F, 0.35F, 0.60F, 0.80F and 1.00F.

In the above five embodiments, indicators representing the respective optical characteristics are summarized in Table 16 below. Here, f_{Back} is a distance from the last lens surface of the optical system to the image plane, and f_{Effective} is an effective focal length of the optical system. In addition, L_{Front} is a distance from the aperture of the optical system to a vertex surface of the object side of the first lens, and L_{Rear} is a distance from the aperture of the optical system to a vertex surface of the image side I of the last lens. In addition, ΔL_{Focusing} is a difference between positions of a focusing group in a direction of an optical axis for the case where the object distance is infinite and for the case where the object distance is an MOD (minimum of distance), and nₐ is a reciprocal of an average refractive index of all lenses used in the optical system.

TABLE 16

| | the first | the second | the third | the fourth | the fifth |
|---|---|---|---|---|---|
| | embodiment | embodiment | embodiment | embodiment | embodiment |
| f_{Effective} | 18.541 | 18.540 | 18.008 | 18.541 | 18.479 |
| f_{Back} | 25.444 | 23.981 | 23.232 | 24.160 | 24.561 |
| L_{Front} | 27.023 | 24.757 | 30.424 | 29.9 | 28.641 |
| L_{Rear} | 18.741 | 17.735 | 11.167 | 17.436 | 18.302 |
| ΔL_{Focusing} | 0.931 | 0.7 | 0.58 | 1.214 | 1.1 |
| nₐ | 0.590 | 0.590 | 0.574 | 0.582 | 0.588 |
| $1.16 \leq \frac{{f}_{Back}}{{f}_{Effective}} \leq 1.51$ | 1.372 | 1.294 | 1.290 | 1.303 | 1.329 |
| $1.26 \leq \frac{{L}_{Front}}{{L}_{Rear}} \leq 2.72$ | 1.442 | 1.396 | 2.724 | 1.715 | 1.565 |
| 0.52 ≤ ΔL_{Focusing} ≤ | 0.931 | 0.700 | 0.580 | 1.214 | 1.100 |
| 1.34 | | | | | |
| $055 \leq \frac{1}{{n}_{a}} \leq 0.60$ | 0.590 | 0.590 | 0.574 | 0.582 | 0.588 |

As described in various embodiments above, the optical system according to the present invention is a lens for photographing with stable resolution operating in a wide-angle area. It is characterized that since it is a short focus optical system, focusing is required to correct a position of an image point that changes depending on a position of a subject, in which the overall length of the optical system is fixed using the inner focusing in order to shorten the length of the overall length of the optical system, and it has a focusing group that is lightweight to realize high-speed auto-focusing (AF).

The first lens group mentioned in the above embodiments is from the first surface to an aperture surface ST, and its combined focal length has a positive refractive power. In this case, the apertures of the lenses included in the second lens group positioned after the first lens group may be reduced, which is advantageous for the high-speed AF. Since it is possible to reduce the weight of the moving lens group by configuring the lens group used for such AF in two or less, and fixing the first and third lens groups in focusing, it contributes to achieve the high-speed AF. Here, In order for the optical system to secure a wide angle of view, the lens positioned on the object side O of the first lens group must have a negative refractive power.

In addition, as described in Table 16, the embodiments of the present invention satisfy the following Equation 2. Here, f_{Back} is a distance from the last lens surface of the optical system to the image plane, and f Effective is an effective focal length of the optical system.

$$1.16 \leq \frac{{f}_{B a c k}}{{f}_{Effective}} \leq 1.51 \qquad [ Equation 2 ]$$

Equation 2 is used to determine a position of a main point to sufficiently secure a back working distance in an optical system having a short focal length. In the case of the present invention, a flange back distance, which is a distance from a mount surface of a camera to a top surface, is relatively short. Therefore, in order to satisfy mechanical limitations of the flange back while having the wide angle of view, it is advantageous that the main point is a retro-focus type outside the lens.

Here, a lower limit of Equation 2 is a condition in which the position of the main point is outside the optical system, and when it exceeds the lower limit, the lens and a body of the camera interfere, making it impossible to construct the optical system. When it exceeds an upper limit of Equation 2, a distance from the image sensor of the camera to a first lens of the optical system becomes long, making it difficult to commercialize.

In addition, as described in Table 16, the embodiments of the present invention satisfy the following Equation 2. Here, L_{Front} is a distance from the aperture of the optical system to a vertex surface of the object side of the first lens, and L_{Rear} is a distance from the aperture of the optical system to a vertex surface of the image side I of the last lens.

$$1.26 \leq \frac{{L}_{Front}}{{L}_{R e a r}} \leq 2.72 \qquad [ Equation 3 ]$$

Equation 3 may be used to appropriately limit a size of a diameter of the lens of the object side or the image side I of the optical system depending on a position of the aperture. When it is outside a lower limit of Equation 3, the aperture is positioned on the image side I than the center of the optical system, and a lens mirror of the object side O becomes large. Conversely, when the aperture is positioned on the object side O, the size of the lens mirror of the image side I is increased. If a size of a product is considered, it is advantageous to position the aperture in the center of the optical system in order to balance the sizes of the lens mirrors of the front and rear groups of the optical system. However, the size of the last lens mirror is limited by the mounting surface of the lens and the mechanism of the body of the camera. Therefore, in the case of the lens having the wide angle of view, the lens mirror of the object side O becomes larger than that of the image side I. In addition, in two cases of Equation 3, the position of the aperture is closer to the image side I than the object side O. As described in Table 16, the embodiments of the present invention satisfy the following Equation 4. Here, ΔL_{Focusing} is a difference between positions of a focusing group in a direction of an optical axis for the case where the object distance is infinite and for the case where the object distance is an MOD (minimum of distance).

0.52≤ΔL_{Focusing}≤1.34 [Equation 4]

Equation 4 is used as a condition for achieving the high-speed AF, and limits the time it takes to AF from a subject very far from the image sensor to the closest distance the optical system allows. When the aberration caused by focusing is large and it is difficult to reduce the weight of the focusing group, it is advantageous to directly limit the amount of movement to reduce the AF time. However, when the amount of focusing movement is too small, there is a problem that the precision required for a driving source is increased and the focusing precision is lowered. A lower limit in Equation 4 is the aforementioned case. When it exceeds an upper limit, the amount of focusing movement increases, which increases the total AF time, and thus is disadvantageous for achieving the high-speed AF.

In addition, as described in Table 16, the embodiments of the present invention satisfy the following Equation 5. Here, nₐ is a reciprocal of an average refractive index of all lenses used in the optical system.

$$0.50 \leq \frac{1}{{n}_{a}} \leq 0.60 \qquad [ Equation 5 ]$$

Equation 5 is used to limit a Petzval curvature of each lens of the optical system. Equation 5 is an average of a material refractive index of each lens, and the larger the material refractive index, the smaller the Petzval curvature. However, when only the material with a high refractive index is used, the cost of materials of the lens increases. On the contrary, when the refractive index is lowered, the unit cost of the materials of the lens may be lowered, but the amount of occurrence of an image plane curvature aberration increases. Therefore, it is advantageous in that the upper and lower limits of Equation 5 limit the amount of materials of the lenses constituting the optical system while effectively suppressing the amount of Petzval curvature.

The aspheric surface used in the optical system according to the present invention is usually used for the object side O or the image side I lens having a large aperture. In this case, it is effective to correct astigmatism and distortion. In addition, it is advantageous for correcting spherical aberration when it is used near an aperture with a high elevation of an axial ray passing through the optical system. However, as the size of the lens mirror where the aspheric surface is used increases, the material cost also increases. The present invention focuses on a design for lightening the focusing group to achieve the high-speed AF. Therefore, the spherical aberration may be corrected by using the aspheric surface in the front lens of the focusing group close to the aperture.

In addition, in the case of the wide-angle optical system covered in the present invention, as described above, the first lens group or the second lens group should be a lens having a positive refractive power and the third lens group needs to be configured to have a negative refractive power in order to converge light of the wide angle of view. Here, the image plane curvature aberration where the image plane is bent toward the object side O occurs, in which the curvature aberration may be corrected by using the last lens of the third lens group having a negative refractive power. A lens that performs this function is called a field flattener, in which the image plane curvature may be corrected by arranging the lens having a negative refractive power at an appropriate position from the optical system.

In general, in the case of the wide-angle optical system, a surface of the object side of the first lens is convex toward the object side O in order to converge light in a wide area. Here, a surface of the image side I of the first lens has a smaller radius of curvature than the surface of the object side O to satisfy OSC (offence against sign condition). Therefore, the first lens is preferably composed of the meniscus lens that is convex toward the object side O. Further, for correcting chromatic aberration in the optical system, one junction lens may be used in the first lens group or the third lens group. The junction lens is corrected to some extent by chromatic aberration itself, and also has adequate power in the entire optical system. Therefore, it provides balancing with other lenses constituting the optical system, contributing to form an image and to minimize chromatic aberration.

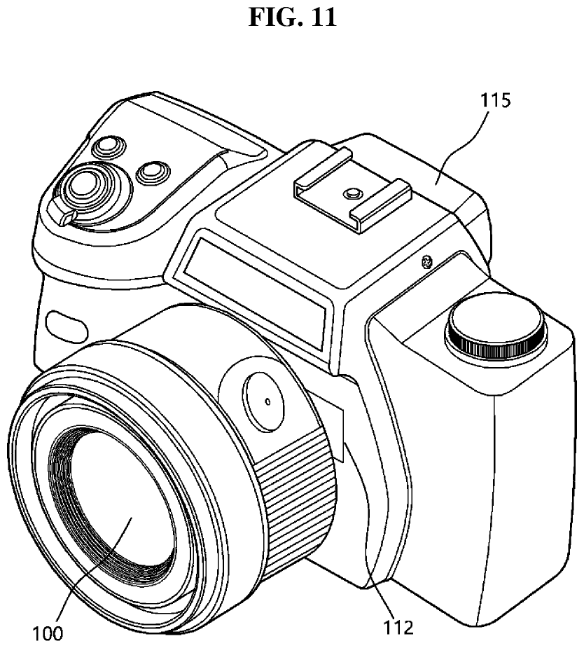

As such, the present invention is characterized in that a length of the optical system is reduced while stably correcting the performance change depending on the position of the object. Therefore, two or more aspheric surfaces including the focusing group were used to suppress the occurrence of aberration due to the shortening of the optical system. When using the aspheric surface, the closer the first or last surface of the optical system, the larger the size of the aspheric surface, which may increase the manufacturing cost. The second lens from the object side O and the second lens from the image side I were adopted to improve the correction effect of astigmatism and distortion aberration caused by the aspheric surface. In addition, it is desirable that the aspheric surface additionally applied for aberration correction be configured as close as possible to the aperture of the optical system to favor the correction of spherical aberration and coma aberration, as described above. FIG. 11 shows a photographing apparatus having the lens optical system 100 according to the embodiments of the present invention. The lens optical system 100 is substantially the same as the lens systems 100-1, 100-2, 100-3, 100-4, and 100-5 described with reference to FIGS. 1, 3, 5, 7, and 9. The photographing apparatus may include an image sensor 112 that receives light formed by the lens optical system 100. And, it may be provided with a display 115 on which an image of a subject is displayed.

The lens optical system according to an exemplary embodiment adopts the inner focusing in which some lenses in a lens system are moved to focus to achieve miniaturization while maintaining a length of an overall length. In addition, the photographing apparatus may be conveniently carried by using the inner focusing.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

What is claimed is:

1. A lens optical system, comprising:
a first lens group in which a first lens of an object side is composed of a meniscus lens having a negative refractive power, and having a positive refractive power as a whole;
a second lens group arranged at an image side I than the first lens group, the second lens group being a focusing group for correcting a change in image distance depending on a change in object distance, being composed of two or less lenses, and having a positive refractive power as a whole; and
a third lens group arranged at the image side I than the second lens group, the third lens group having a negative refractive power as a whole, in which a first lens of the image side I is composed of a concave or meniscus lens,
wherein when the second lens group is focused while moving, the first lens group and the third lens group are fixed to have a constant length of an overall length.

2. The system of claim 1, wherein the lens optical system satisfies the following equation:
$$1.16 \leq \frac{{f}_{B a c k}}{{f}_{Effective}} \leq 1.51 ,$$
where f_{Back} is a distance from a surface of the last lens of the lens optical system to an image plane, and f_{Effective} is an effective focal length of the lens optical system.

3. The system of claim 2, wherein the lens optical system satisfies the following equation:
$$1.26 \leq \frac{{L}_{Front}}{{L}_{R e a r}} \leq 2.72 ,$$
where L_{Front} is a distance from an aperture of the optical system to a vertex surface of the object side of a first lens, and L_{Rear} is a distance from the aperture of the optical system to a vertex surface of the image side I of the last lens.

4. The system of claim 3, wherein the lens optical system satisfies the following equation:
0.52≤ΔL_{Focusing}≤1.34,
where ΔL_{Focusing} is a difference between positions of a focusing group in a direction of an optical axis for the case where the object distance is infinite and for the case where the object distance is an MOD (minimum of distance).

5. The system of claim 4, wherein the lens optical system satisfies the following equation:
$$0.5 \leq \frac{1}{{n}_{a}} \leq 0 \text{.60} ,$$
where nₐ is a reciprocal of an average refractive index of all lenses used in the optical system.

6. The system of claim 5, wherein the second lens group comprises at least one aspheric surface.

7. The system of claim 5, wherein the last lens of the image side I included in the third lens group has the negative refractive power.

8. The system of claim 5, wherein the first lens of the object side O included in the first lens group is the meniscus lens convex toward the object side O.

9. The system of claim 5, wherein the first lens group or the third lens group comprises one or more junction lenses.

10. The system of claim 9, wherein the first lens group or the third lens group comprises at least one aspheric surface.
